(19) United States
(12) Patent Application Publication
(10) Pub. No.: US 2003/0074603 A1
(43) Pub. Date: Apr. 17, 2003

(54) Automatic generation of diagnostic programs for SPS-controlled systems

(76) Inventors: Ulrich Bungert, Stein (DE); Frank Dittrich Schiller, Erlangen (DE)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/972,365

(22) Filed: Oct. 5, 2001

Related U.S. Application Data
(60) Provisional application No. 60/318,180, filed on Sep. 7, 2001.

(51) Int. Cl. G06F 11/30

(52) U.S. Cl. 714/37

(57) ABSTRACT

An automation system wherein fault conditions are identified by providing clearer fault messages. The system is defined in terms of components, and further in terms of inputs, outputs, and functional relationships between the inputs and outputs, wherein inputs include potential fault conditions associated with the components or functional elements. Weighting factors are associated with the fault conditions to identify the most likely cause. Functional relationships are developed using libraries of generic components that are used to create a diagnostic program during an off-line phase (410). Model functions (412) are determined and coded according to a suitable coding language (414). The resulting program is passed as a diagnostic model (426) operable of use in an on-line phase (420). The diagnostic model (426) provides input to an object engine (430) that is operational during the on-line phase (420), and receives specific inputs (424) and outputs of selected information (422) during operation thereof.

### BACKGROUND OF THE INVENTION

1. Field of the Invention

This invention relates to the field of software programs used in automation systems. More specifically, the invention relates to the generation of diagnostic programs for fault analysis in automation systems.

2. Background of the Related Art

Since the time that Henry Ford started implementing the concept of a production line, the manufacture of parts has increasingly involved the use of automation systems.

Manufactured parts, in their developmental cycle, are moved from one station to the next by means of actuators or transport mechanisms such as conveyor belts, cranes, robotics systems, and other means. All these actions are typically enabled by means of one or more industrial controllers, e.g., a PLC (Programmable Logic Controller). The controller receives as an input information about the present status of the plant from sensors that are strategically placed at various points. The controller then processes the information to determine the necessary values for the actuators. A fault in any of these mechanisms can lead to costly delays, not only in the particular section involved, but by creating a bottleneck at the breakdown point, which results in a domino effect. Ideally, the location and cause of a fault should be ascertainable in a minimal amount of time. To this end, sensors are placed at various locations in automation systems, providing feedback to a central location.

In the past, a common approach has been to create programs on an ad hoc basis to provide application-specific solutions using rule-based diagnostics. Due to the complexity involved in large systems, this approach invariably limits the amount of detail that is possible. In the case of small systems, another approach has been to use quantitative models in which a process of observation-and-parameter-value estimation is adopted, followed by substantive evaluation of the values. Yet another approach has been to use symbols in conjunction with qualitative models to define deviations. The complexity of the models and the use of symbolic programming languages has made integration of such approaches into automation systems and rapid transformation of outputs virtually impossible. Even where simple logic relationships are defined relating the various sensor outputs to certain fault conditions, these relationships are generally expressed in cryptic terms that require further interpretation, and do not provide a solution in real time. Furthermore, static relationships typically are insufficient to achieve a realistic analysis, since the triggering of certain signals may relate to a fault that took place at an earlier point in time. For instance, a work piece being moved on a conveyor belt from a first location to a second location, with sensors at both locations, will trigger first one and then the other sensor under normal operating conditions. However, if the conveyor belt breaks down, thereby failing to trigger the second sensor, this only becomes apparent if read in conjunction with a timer input that ties a sequence of events to a time schedule. Furthermore, faults typically require the consideration of a number of sensor signals to allow for an adequate analysis of the problem, since different combinations of signals define different fault conditions.

### SUMMARY OF THE INVENTION

The present invention disclosed and claimed herein, in one aspect thereof, proposes diagnosing faults in systems by developing fault models and automatically transforming them into diagnosis programs executable on a PLC, in addition to the controller programs. These models are created by defining components in a system and making use of component libraries to assist in assembling functional relationships. The component libraries are created by defining generic component types. For instance, a class of sensors will constitute a generic component type, since classes of sensors behave the same way, irrespective of where they are used. A specific component can then be defined based on its inputs and outputs, and plugging in appropriate generic types with pre-defined relationships. The components are hierarchically structured and may themselves be made up of components.

Thus, faced with a system of moving parts, the system can be defined as a set of interacting components. The functional relationships for each component can then be defined using the component libraries. In this way, a modular approach is adopted in creating a system model. The functional relationships for the components can take the form of equations relating inputs to outputs. In order to account for fault conditions, fault functions are included on the requirement side of the model equation.

Thus, a particular component may describe how a present input value and a present fault cause the present output value of this component. However, the present invention proposes including time dependencies. Thus the functional relationships of a component describes how a present input value, a present state value, and a present fault cause the present output value and the next state value. Furthermore, the fault models relate cause and effect as they appear in nature. Thus relations might be valid with a probability, i.e., the conditional probability of the present output value and next state value conditioned on the present input value, a present state value, and a present fault. However, for the solution of diagnostic tasks, a conclusion has to be reached from observed effects (measured values, which are typically subsets of inputs and outputs) as to which faults are definitely causes.

The relations of the fault models are transformed to relations necessary for diagnosis. The transformation involves the transformation to logical equivalents, taking into consideration the probabilities. The transformed relations are expressed by a programming language suitable for execution by, for example, a PLC. The diagnostic programs are run on the PLC, in addition to the controller programs operating therein.

According to the invention, there is provided a method of assessing fault conditions in an automation system, which comprises identifying functional blocks in the system, defining inputs and outputs for each functional block, including possible fault conditions as inputs, defining functional relationships between inputs and outputs for each component, preferably for both the existence and non-existence of each fault condition for each functional block, and identifying any fault condition based on the functional relationships and outputs and other inputs. Typically the other inputs comprise sensor feedback signals from the automation system. Preferably a component library is created defining the inputs and outputs and functional relationships of common generic components. The method preferably uses the functional relationships of the components in the library, and inputs and outputs of specific components to identify fault conditions. The method typically includes creating a control program from the functional relationships of the generic components associated with each component.

Where more than one fault condition is possible, the method of the invention preferably includes ascribing weighting factors to define the likelihood of the occurrence of each fault. Typically the method is implemented in an on-line and an off-line phase wherein the off-line phase comprises the generation of a diagnostic program from the various input, outputs, and functional relationships, and the on-line phase includes diagnosis of the system using the diagnostic program. Typically, the diagnostic program involves creating an algorithm using a symbolic language like LISP or Prolog to produce a diagnostic program in a language such as SCL (Structured Control Language) or C++, which is then run on the PLC.

Further, according to the invention, there is provided a method of defining control code for an automation system, comprising identifying the functional elements in the system, defining inputs and outputs for each functional element including defining fault conditions as inputs, defining functional relationships between desired and undesired outputs and associated inputs for each functional element, and, during operation of the system, identifying fault conditions based on inputs and outputs to the functional elements, and the functional relationships.

The functional relationships for at least some of the functional elements may be obtained by creating a component library that defines functional relationships between inputs and outputs of generic elements. During operation, the fault conditions are identified by using the functional relationships of the component libraries and inserting input and outputs of the functional elements. Typically, a diagnostic program is created from the functional relationships and inputs and outputs of the generic elements corresponding to the functional elements in the system.

In order to define the likelihood of one fault condition over another being the cause of an undesired output, weighting factors may be assigned to the fault conditions.

### BRIEF DESCRIPTION OF THE DRAWINGS

For a more complete understanding of the present invention and the advantages thereof, reference is now made to the following description taken in conjunction with the accompanying Drawings in which:

FIG. 1 is a table as used in the invention, relating fault conditions, to their symbols and the effect they have;

FIG. 2 is a simple SPS controlled system;

FIG. 3 is a schematic representation of the system of FIG. 2;

FIG. 4 is a block diagram showing the steps involved in the invention; and

FIG. 5 is a table showing a sample analysis of fault conditions.

### DETAILED DESCRIPTION OF THE INVENTION

The invention proposes the development of a model. Initially, in order to model a system, substantially all of the faults that may occur in the system are listed and symbolically represented, and their effect noted.

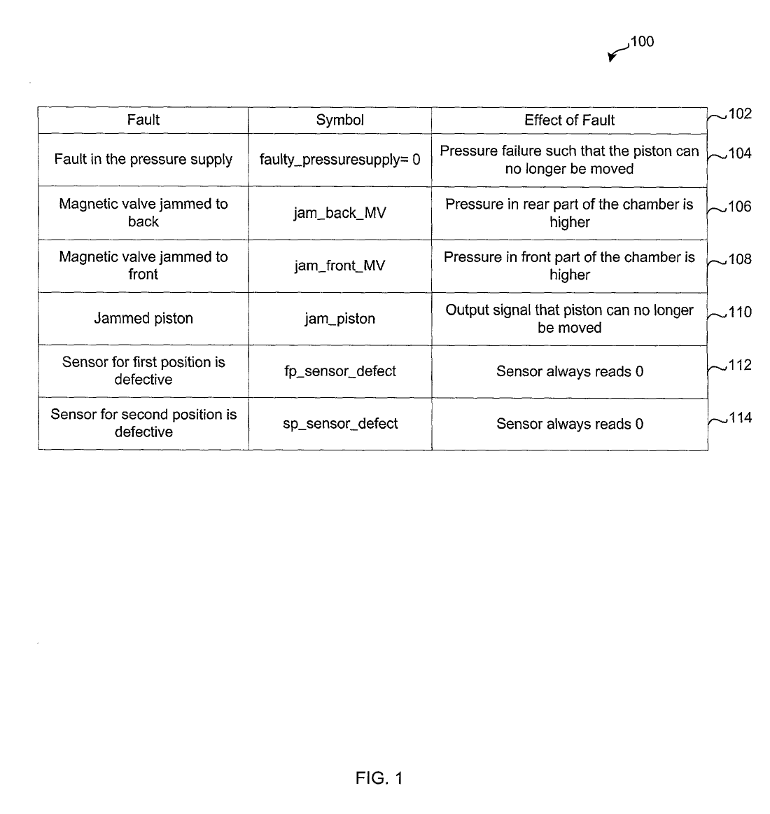

Referring now to FIG. 1, there is illustrated a sample table of various faults, the corresponding symbols, and a description of the effect of the fault. The table 100 contains a first row 102 of header information for the fault, the corresponding symbol, and the effect of the fault. For example, in a second row 104, a fault in a pressure supply is communicated utilizing a symbol of faulty_pressuresupply=0. The effect of the fault is that a mechanical device associated therewith, for example, a piston, can no longer be moved or driven as a result of loss of air pressure from the pressure supply. Similarly, in a third row 106, a magnetic solenoid valve is in a fault mode where the valve being controlled is jammed in a back position. The corresponding symbol is jam_back_MV with the associated fault effect that pressure is higher in a rear portion of the piston chamber. In a fourth row 108, the magnetic solenoid valve is in a fault mode where the valve being controlled is jammed in a forward (or front) position. The corresponding symbol is jam_front_MV with the associated fault effect that pressure is higher in a front portion of the piston chamber. In a fifth row 110, the piston is in a fault mode such that it is jammed, i.e., restricting motion in any direction. The corresponding symbol is jam_piston with the associated fault effect that the piston cannot be moved. In a sixth row 112, a first sensor affiliated with a first position of the piston is in a fault condition where the sensor has failed. The corresponding symbol is fp_sensor_defect with the associated fault effect that the sensor outputs a signal to the controller indicating a zero or fault condition. Lastly, for this particular embodiment, in a seventh row 114, a second sensor affiliated with a second position of the piston is in a fault condition where the sensor has failed. The corresponding symbol is sp_sensor_defect with the associated fault effect that the sensor outputs a signal to the controller indicating a zero or fault condition.

The tabular recording of the faults and the effect is followed by the creation of the model. This is component-based wherein the various components of the system are individually considered for the relationships that can occur as well as the resultant outputs that flow form these relationships.

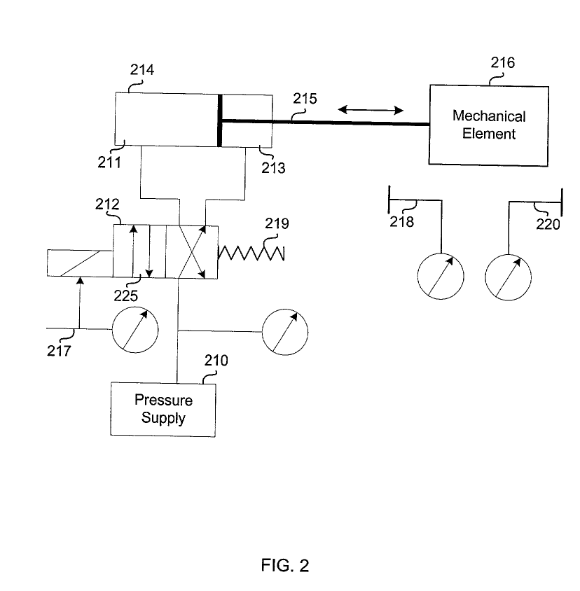

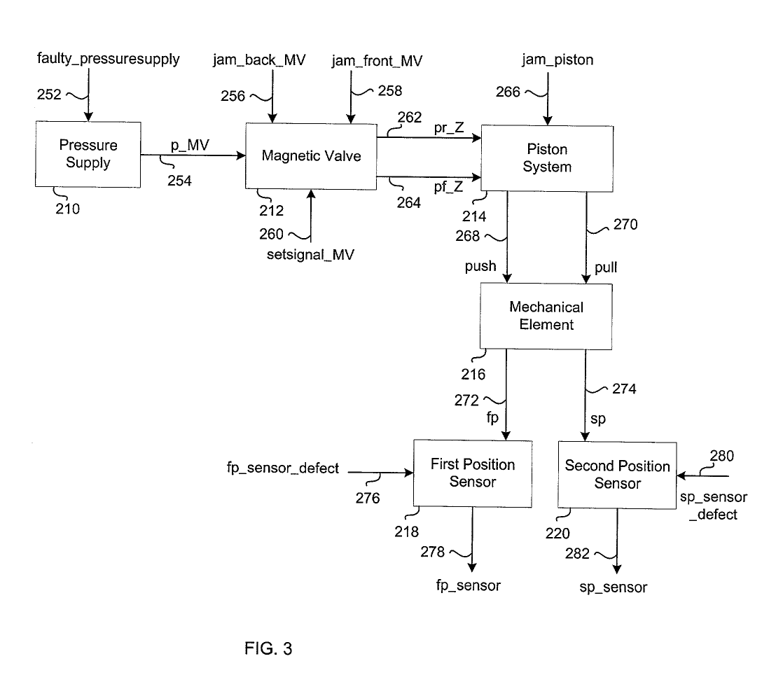

Referring now to FIG. 2, there is illustrated a simple system, according to a disclosed embodiment. The system includes a pressure supply 210 for supplying a pressure p_MV to the system, a magnetic solenoid valve unit 212 for controlling the flow of air from the pressure supply 210 into a piston chamber 214 to control the movement of a piston 215 in the chamber 214, and a mechanical element 216 which operatively connects to the piston 215. The piston chamber 215 also has a front portion 211 and a rear portion 213. Movement of the piston 215, in turn, results in movement of the mechanical element 216. (The input and output signals involved in the operation of the system are shown hereinbelow in FIG. 3.)

The valve unit 212 includes an on/off switch 217 (setsignal_MV) which controls the movement of a valve element 225 against a spring 219. The valve element 225 is known to jam occasionally in a back or front position, as defined by jam_back_MV and jam_front_MV, respectfully. Under normal fault-free working conditions, the corresponding symbol relationship can be expressed as follows:

setsignal_MV & p_MV & −jam_back_MV [symbol] pb_Z, where pb_Z is the resultant pressure increase in the back of the piston chamber 214.

A fault relationship that includes a jam in the back position, resulting in a pressure increase in the front of the piston chamber 214 (pf_Z), may take the form of the following:

setsignal_MV & p_MV & jam_back_MV [symbol] pf_Z.

In practice, all the faults that may occur in the system are listed and symbolically represented, and their effect noted, as indicated in the table 100 of FIG. 1. The tabular recording of the faults and the corresponding effect is followed by the modeling phase. Continuing with the simple scenario illustrated in FIG. 2, instead of considering the system as a whole, the system is now segmented into six components: a pressure supply 210, a magnetic valve unit 212, a piston 215, a mechanical element 216 that is moveable between a first position and a second position, a first position sensor 218 for sensing the mechanical element when in the first position, and a second position sensor 220 for sensing the mechanical element when in a second position. Considering the pressure supply component 210, analysis can be made of normal operating conditions and fault conditions by considering the input and output values.

Referring now to FIG. 3, there is illustrated a schematic representation of the system of FIG. 2. The input includes a faulty pressure supply input 252 (faulty pressuresupply). The relationship for normal operation can be defined as follows:

−faulty_pressuresupply [symbol] p_MV.

A fault condition in pressure is considered relevant if the pressure drops below three bar (−p_MV). The measurable signal output is the pressure (p_MV) and is used in reverse to determine the presence or absence of a faulty pressure supply 210. The relationship for such a condition is given as follows:

faulty_pressuresupply [symbol] −p_MV.

The magnetic valve unit 212, in turn, has three inputs: two of which indicate potential faults and one to set the valve unit 212 in an on or off state. The symbol Jam_back_MV 256 indicates that the valve is jammed in its backward position, while jam_front_MV 258 indicates that the valve is jammed in its front position. The symbol setsignal_MV 260 indicates whether the valve on/off switch 217 which controls the magnetic valve unit 212, is in an on or off position. Furthermore, the valve unit 212 receives the input p_MV 254 from the pressure supply component 210. Under normal operating conditions, the setsignal_MV 260 has a value of one and the magnetic valve 212 opens by exerting a force against the spring 219. This allows the air pressure from that pressure supply component 210 to be channeled to the piston chamber 214 to exert a higher pressure in the rear portion 213 of the piston chamber 214. This is denoted by an output signal on the output pr_Z 262. In contrast, when the setsignal_MV 260 has a value of zero (−setsignal_MV), the valve 212 is closed causing a higher pressure in the front portion 211 of the piston cylinder 214, resulting in an output signal pf_Z 264. These relationships can be expressed as follows:

setsignal_MV & p_MV & −jam_back_MV [symbol] ph_Z, and

−setsignal_MV & p_MV & −jam_front_MV [symbol] pf_Z, wherein the symbol 256 (−jam_back_MV) indicates that the magnetic valve 212 is not jamming in a backward position, and symbol 258 (−jam_front_MV) indicates that the valve 212 is not jammed in a front (or forward) position.

Thus these two equations indicate normal operation of the magnetic valve unit 212. In contrast, when the valve 212 jams in its front position under normal pressure supply conditions, then irrespective of the value of the setsignal_MV 260, a high pressure is created in the rear portion 213 of the piston chamber 214. This is represented by the following relationship:

p_MV & jam_front_MV [symbol] pr_Z.

Similarly, when the valve 212 jams in its backward position, a high pressure is established in the front portion 211 of the piston chamber 214. This is given by the following relationship:

p_MV & jam_back_MV [symbol] pf_Z.

If the pressure supply p_MV drops below three bar, neither the front portion 211 nor the rear portion 213 of the piston chamber 214 is supplied with sufficient pressure, as indicated by the following relationship:

−p_MV [symbol] −pf_Z & −pr_Z.

The two inputs to the valve unit 212, i.e., the setsignal_MV 260 and the pressure supply signal p_MV 254, are continuously measured. These, together with the outputs pr_Z 262 and pf_Z 264 allow the relationships to be solved for the potential fault conditions jam_back_MV 256 and jam_front_MV 258.

The piston chamber 214 is analyzed for inputs and outputs in much the same way. It includes the two pressure inputs pr_Z 262 and pf_Z 264, and a fault condition jam_piston 266. It also includes two outputs: a push 268 and a pull 270. Depending on the pressure difference between pr_Z 262 and pf_Z 264, the piston 215 is either pushed or pulled in the absence of a jam_piston fault condition, as indicated by the input 266. These relationships include the following:

pr_Z & jam_piston [symbol] push, and

pf_Z & −jam_piston [symbol] pull.

If the piston 215 jams, or the pressure difference is too small, neither a push or pull movement of the piston 215 is achieved. This is depicted as in the following relationships:

jam_piston [symbol] −push & −pull, and

−pr_Z & −pf_Z [symbol] −push & −pull.

Similarly, the mechanical element 216 is reduced to a component level. The element 216 receives the push input 268, the pull input 270, and moves between a first position fp 272 and a second position sp 274. The mechanical element 216 comprises all moving parts external to the piston 215. During a push movement of the piston 215, the mechanical element 216 moves from the first position fp at time slot k to an intermediate position −fp(k+1) & −sp(k+1) at time slot k+1. This is given by the following relationship:

push & fp [symbol] −fp(k+1) & −sp(k+1).

From this intermediate position, continued pushing by the piston 215 moves the mechanical element 216 to its second position. Again, an arbitrary time slot is defined between time slots k and k+1, and the relationship is given by the following:

push & −fp & −sp [symbol] sp(k+1).

Further pushing of the piston 215 will not change the situation, and the mechanical element 216 remains at the second position sp. Thus the relationship is as follows:

push & sp [symbol] sp(k+1).

In the case of a pull of the piston 215, a movement takes place from the second position to the first position via an intermediate position, which is neither the first nor the second position. When neither a push nor a pull is exerted by the piston 215, the mechanical element 216 remains in its current position. For example, if the mechanical element 216 was in its first position, the relationship would be as follows:

−push & −pull & fp [symbol] fp(k+1).

The component constituting the first position sensor 218 receives the first position input 272 and a fault condition input in the form of a first position sensor defect (fp_sensor_defect) 276. It also includes a first position sensor output (fp_sensor) 278. Under normal operation (−fp_sensor_defect), the sensor produces an output of one for the fp_sensor when the mechanical element 216 is in its first position (fp). The corresponding relationship is as follows:

fp & −fp_sensor_defect [symbol] fp_sensor.

The first sensor 218 produces a zero output when the mechanical 216 is not in its first position or the sensor 218 experiences a defect, as indicated by the following relationships:

−fp [symbol] −fp_sensor, and

fp_sensor_defect [symbol] −fp_sensor.

The output (fp_sensor) 278 is available as a measurable value to provide feedback on possible sensor 218 defects, or positional information of the mechanical element 216.

The second sensor component 220 receives the second position input (sp) 274 as sensor defect input (sp_sensor_defect) 280, and emits a second sensor output (sp_sensor) 282. The sensor 218 operates in much the same way as described above for the sensor 220. Thus the following relationships may be defined:

sp & −sp_sensor_defect [symbol] sp_sensor, −sp [symbol] −sp_sensor, and sp_sensor_defect [symbol] −sp_sensor.

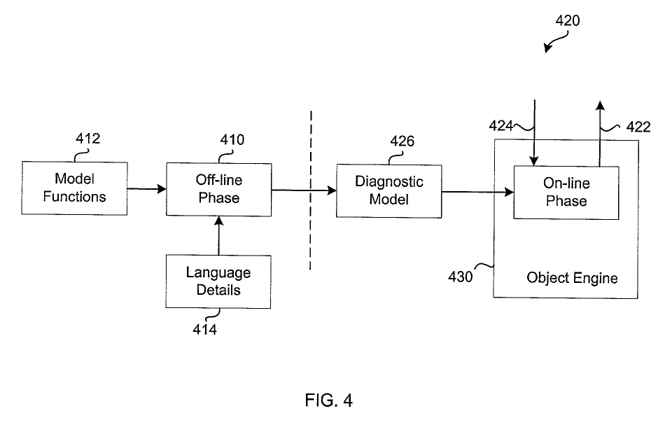

Referring now to FIG. 4, there is illustrated the relationship between the off-line phase and the on-line phase, according to a disclosed embodiment. The fault model for the diagnosis of a system is typically created at the time that the control for the system is being designed. In a typical diagnosis, the object is to identify the faults from the sensor feedback. By applying the sensor feedback values to the model, an output can be calculated that identifies the fault condition. Since this calculation is normally time-critical, one proposal to reduce the analysis delay at the time of diagnosis is to divide the diagnosis into an off-line 410 and on-line phase 420. During the off-line phase 410, a diagnostic program is created from a system model, taking into account the hardware and software environments in which the on-line phase 420 will be operating. The off-line phase 410 can, for instance, be implemented using symbolic programming languages such as LISP or PROLOG. The program is generated using the general functional relationships and associated inputs and outputs captured in the component library. The resultant program, which may be coded in C++ or SCL, is used in the on-line phase 420. During the on-line phase 420, sensor feedback values are entered into the diagnostic program to provide the system-specific inputs and outputs, and allow the unknowns to be solved, i.e., the above fault outputs to the components which constitute the various potential fault conditions. During the off-line phase 410, the diagnostic program is generated based upon inputs involving the model functions 412 and the language details 414. During the on-line phase 420, the sensor outputs are applied as input values 424 to the diagnostic program created during the offline phase 410.

Due to the many fault combinations and the fact that the combinations may include fault conditions that occurred in the past, different fault conditions may be associated with a single set of inputs. In order to deal with this scenario, the likelihood of a fault condition over another is numerically defined. By monitoring the number of times a particular fault occurs, a weighting factor is ascribed to each fault condition. Thus, when a fault output occurs having various possible fault conditions associated with it, the most likely one can quickly be determined. For instance, if the weighting factor has a value of one, it means that the associated fault condition definitely occurred. At the other end of the spectrum is weighting factor of zero, meaning that the fault condition definitely did not occur and can be excluded.

In the system of FIG. 3, the externally-measured values that are used for the analysis are the two output sensor values fp_sensor 278 and sp_sensor 282, the pressure p_MV 254 supplied by the pressure supply 210 to the magnetic valve 212, and the setsignal_MV 260.

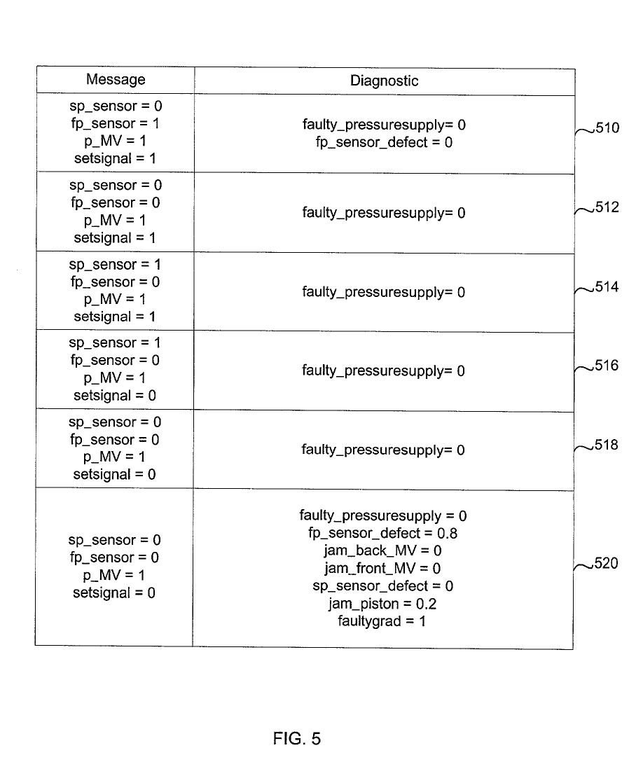

Referring now to FIG. 5, there is illustrated a table of the measured signal values and corresponding diagnostic results for the scenario where the mechanical element 216 moves from a first position (on the left) to a second position (to the right) via an intermediate position, and then partly retracts. Considering each step in turn, a step 510 associates the mechanical element 216 in its first position. Thus, the first position sensor 218 will show a reading above three bar, as indicated by the value of sp_sensor=1, and the second position sensor 220 will show a reading of zero (sp_sensor=0). The pressure p_MV=1 is measured as normal, in this example, and the value setsignal_MV=1 is also measured as normal. Under these conditions, the possibility of a faulty pressure supply 210 can be excluded, since the value p_MV is one. Therefore, the weighting factor for this fault condition is zero. Similarly the fp_sensor defect can be excluded since the first sensor 218 produces the output signal fp_sensor 278 having a value of one.

In a step 512, where the mechanical element 216 has moved to the right to an intermediate position under normal pressure conditions (p_MV=1), the possibility of a fault in the pressure supply 210 can be excluded (faulty_pressuresupply=0) since the pressure value 254 of p_MV=1. However, a sensor defect cannot be excluded, since both the first and second sensors (218 and 220) produce a reading of zero, and could therefore conceivably, be faulty.

In a step 514, the mechanical element 216 moves to the second position. The second sensor 220 provides an output signal of sp_sensor=1 in response thereto, and the first position sensor 218 outputs a value of fp_sensor=0. The valve unit 212 maintains a value settsignal=1, since the solenoid needs to continue to remain in this position to allow air pressure to force the piston 215 to the right.

In a step 516, the value setsignal_MV goes to zero to switch the valve element 225 in preparation for moving the piston 215 in the opposite direction. The positional readings of fp_sensor and sp_sensor remain the same since the position of the piston 215 has not changed.

In a step 518, the mechanical element 216 starts moving back toward the first position, as it should. Since the value setsignal_MV=0 and p_MV=1, conditions are set to cause greater air pressure in the rear portion 213 of the piston chamber 214 than the front portion 211, moving the piston 215 to the left.

In a step 520, the mechanical element 216 was expected to have returned to the first position, causing the value fp_sensor to change to one. However, a fault has occurred preventing this from happening. As shown in the table of FIG. 5, either the first sensor 218 is defective or the piston 215 is stuck. The possibility that the first sensor 218 (fp_sensor_defect) is defective is assigned the weighting factor 0.8 based upon past history that it is more likely that the first sensor 218 is defective than the piston 215 being stuck. The value jam_piston gets a weighting factor of only 0.2.

Thus the various relationships created using the component approach described hereinabove can be used to analyze fault conditions. It will be appreciated that the results will not lead to a determinative outcome if two fault conditions have the same weighting factor. Also, the analysis assumes the occurrence of only one fault at a time. Clearly, for example, it is possible that the second position sensor 220 in step 520 is also defective, but this is not evident from the information available and would only come to light once the first fault is addressed, and operation of the system resumes.

The present invention has been described with reference to a particular sample system, and a certain nomenclature was adopted to define the various components, signals and conditions. It will be appreciated that different embodiments could be created without departing from the essence of the invention as claimed in the attached claims.

What is claimed is:

1. A method of identifying fault conditions in an automation system, comprising the steps of:
identifying components in the system,
identifying inputs and outputs to each identified component, the inputs including possible fault conditions and other inputs,
determining functional relationships between the inputs and outputs for each identified component, and
determining fault conditions based on the functional relationships and the outputs and other inputs.
